(19) United States
(12) Patent Application Publication
(10) Pub. No.: US 2014/0098019 A1
(43) Pub. Date: Apr. 10, 2014

(54) DEVICE DISPLAY LABEL

(71) Applicant: Stefan Kristo, Molnlycke (SE)

(72) Inventor: Stefan Kristo, Molnlycke (SE)

(21) Appl. No.: 13/645,967

(22) Filed: Oct. 5, 2012

(51) Int. Cl. G09G 5/00; G06T 1/00

(52) U.S. Cl. 345/156; 345/501

(57) ABSTRACT

Devices and/or accessories for devices, and/or packaging associated with the same comprise a display label configured to display different types of information and content relating to the device and/or accessory to a user or viewer.

### FIELD

This disclosure relates to devices and/or accessories, and/or packaging for the same, having an improved display label.

### BACKGROUND

Conventional small electrical devices and/or accessories include hand-held devices and/or devices worn by a user e.g., audio players, cell phone remote microphones and receivers, and the like). A further example of such small electrical devices include medical devices such as hearing prosthesis that include certain external components, e.g., components worn by a recipient on their head by or attached to their ear, which external components may include sound input devices, sound processors, sound output devices, combinations of these, and the like.

Such small electrical devices can also include accessories that are used with the devices, such as battery chargers and the like when the devices are remotely powered. Such small electronic devices and accessories are typically packaged in containers or the like for purpose of distribution and ultimately sale to the end user or recipient.

These small devices and/or accessories are typically packaged prior to sale to include a printed label, e.g., made from paper or plastic, that is attached to an external surface of the device or accessory itself that provides certain information regarding the device or accessory. Such conventional printed labels necessarily provide fixed information content, as the information provided by the label is printed thereon and does not change. Because of the relatively small size of such small devices and/or accessories used therewith, the amount of fixed content information that can be realistically displayed on such conventional printed labels is relatively limited, thereby limiting the amount of information relating to the device that can be conveyed to the consumer or recipient, which may not be sufficient for purposes of making a purchase decision and/or subsequently using the device.

### SUMMARY

Devices and/or accessories for devices, and/or packaging for such devices and/or accessories comprising a display label or simply display are disclosed herein. In an example, the device can be a small electrical device, and in a specific example the device can be a component of a hearing prosthesis. The display can be attached to the device, an accessory for the device, or packing for the device or accessory, and comprises a screen for viewing display content relating to the device or the accessory associated with the display. Unlike conventional printed labels, the display as disclosed herein permits viewing via the screen a variety of different display content. Assemblies as disclosed herein include such devices, and/or packaging for such devices, and or accessories for such devices, that include the display label or simply display disposed thereon.

The display and/or the device, accessory or packaging that the display is attached to can include a user interface for activating the display and changing the display content being shown on the screen. The display content can be stored within the display itself or may be stored within the device or accessory or packaging. The display content displayed by the display can be different depending on the particular user. The display can be powered internally, or can be powered by the device, accessory, or packaging associated with the same.

In an example, the display is provided in the form of a thin-film construction and is attached to an external surface of an electrical device. In an example, where the electrical device is a component of a hearing prosthesis, the display content comprises information relating to the hardware and/or software used with the device, any hardware or software upgrades, program settings for the device, stored performance parameters, battery type, battery charge state, and the like.

### BRIEF DESCRIPTION OF THE DRAWINGS

These and other features and advantages of assemblies comprising displays, and electrical devices, packaging, and/or accessories comprising the same, will be appreciated as the same becomes better understood by reference to the following detailed description when considered in connection with the accompanying drawings.

FIG. 1 is a perspective view of a small electrical device comprising a conventional label attached thereto;

FIG. 2 is a perspective view of an example display as disclosed herein;

FIG. 3 is a schematic block diagram illustrating different features of the display as disclosed herein;

FIG. 4 is a perspective view of an example assembly comprising a hearing prosthesis component and/or accessory comprising a display as disclosed herein;

FIG. 5 is a schematic block diagram illustrating different features of the display as disclosed herein attached to a component of a hearing prosthesis;

FIG. 6 is a is a perspective view of an example hearing prosthesis having an external component comprising a display as disclosed herein; and

FIG. 7 illustrates screen shots or pages from an example display as disclosed herein illustrating examples of different types of display content.

### DETAILED DESCRIPTION

Small devices such as electrical devices and/or accessories and the like comprising display labels or simply displays are disclosed herein as generally comprising a thin-film construction that is configured to provide a visual display a variety of different information provided in the form of text, data, and/or graphics provided for example in different screen shots or pages on the same display screen. In an example, this information is related to the device and/or accessory and can be accessed by a user interface with the display or the device and/or accessory. Further, this information can include operational data relating to the state of the device and/or accessory, and/or can include the information relating to the initial state and/or any upgraded or modified state of the device and/or accessory. Additionally, such displays as disclosed herein can be used in conjunction with the packaging for such devices and/or accessories instead of with the devices and/or accessories themselves.

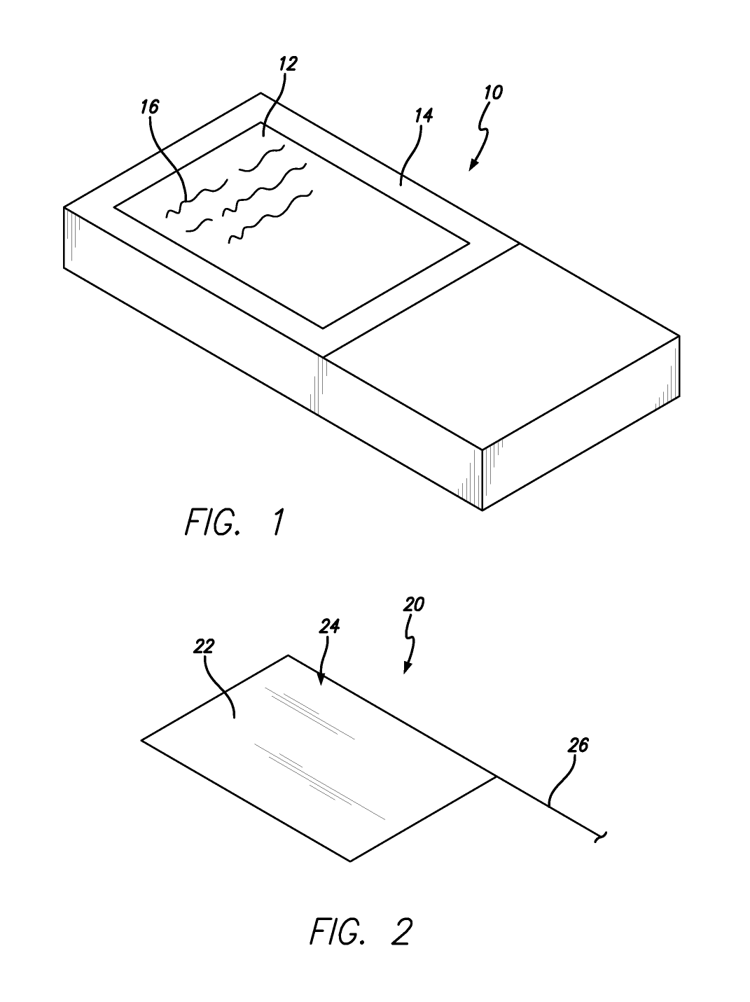

FIG. 1 illustrates a conventional small device or accessory 10 having a conventional printed paper or plastic label 12 attached, e.g., adhesively, to an external surface 14. The device 10 can be an electrical device. As briefly described above, such conventional printed labels 12 are of a fixed display content, in that they are only capable of providing the information 16 that is originally printed thereon. As noted above, in the case where the device and/or accessory is of relatively small size, so too is the label so that any information that is provided by such label on the device is necessarily limited in content. As a result, a consumer looking to acquire the device, or a user who has purchased the device, may not be provided with a sufficient amount or type of information needed to make a purchase decision or to correctly use or service the device.

FIG. 2 illustrates an example display 20 as disclosed herein having a display or screen 22 along an exterior surface 24, and that is configured to show multiple screens or pages of display content, e.g., information in the form of text, data, graphics, and combinations thereof, in the screen 22. In an example, the display 20 is provided in the form of a thin construction, e.g., a thin-film construction, capable of being adhered or otherwise attached to an external surface of a small electrical device and/or a small accessory used with such device, and/or packaging for such devices and/or accessories. If desired, the thin-film construction can be flexible to accommodate a contour or other nonplanar shape of the underlying device external surface if called for by the end-use application.

The display may comprise thin-film technology using liquid crystal technology or the like. In an example, the display comprises a thin-film display construction incorporating liquid crystals, and is configured to provide a desired display content on the screen. Examples of such thin-film display constructions useful in this regard include those commercially available from such manufactures as HP, Fujitsu and Sony.

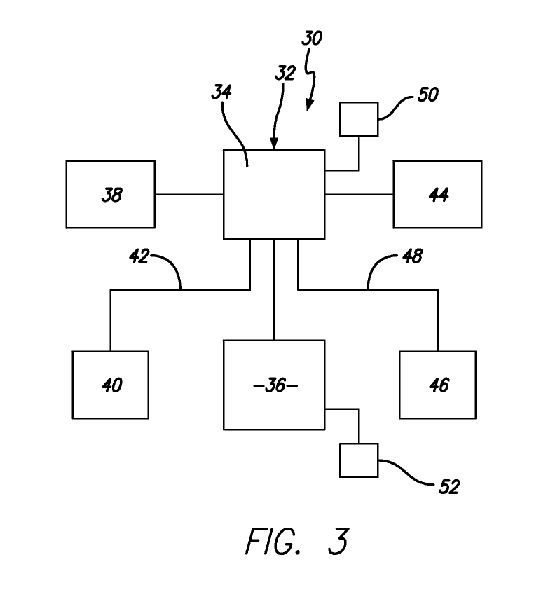

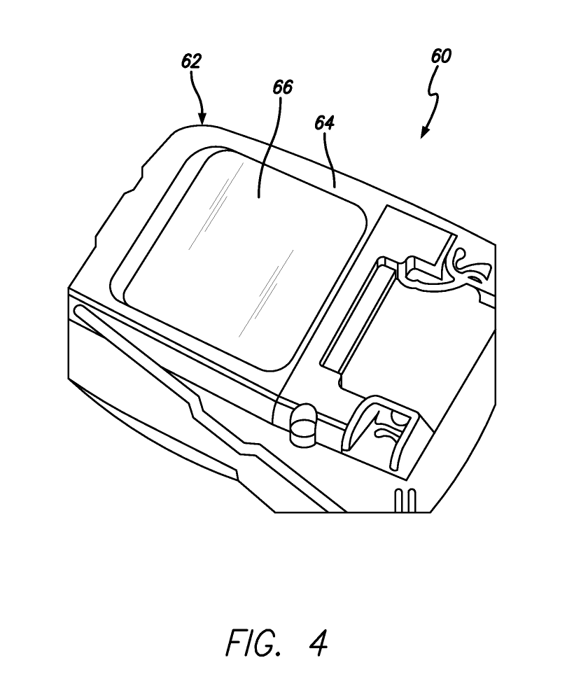

FIG. 3 illustrates in block diagram form various functional features of an example assembly or display construction 30 (comprising the display and a device, accessory or packaging it is attached with) as disclosed herein. In an example, the display construction 32 comprises the display 32 with the screen 34 for viewing display content. The display 32 can be self-powered by a battery 38 that is part of, or integrated with the display itself. Alternatively, the display 32 may derive its power from power source 40 such as a battery or the like that is disposed within or otherwise connected to the device, accessory or packaging 36 that the display is attached to, e.g., through the use of a cable 42 or the like.

In an example, the display 32 can comprise a memory element 44 disposed therein so that the display content to be shown on the screen is self-contained within the display 32 itself. Alternatively, the display 32 can derive its display content from a memory element 46 that is disposed within or otherwise connected with the device, accessory or packaging 36 that it is attached to, e.g., through the use of a cable 48 or the like. In an example, a common cable can be used to both provide power and display content to the display from the respective power source 40 and memory element 46 of the device, accessory or packaging. Alternatively, the display content can be provided wirelessly from such device, assessor or packaging.

In an example, the display is a thin-film construction that is sized for placement on the particular device, accessory or packaging, and having a desired display area or screen size. Referring still to FIG. 3, the display 32 and/or the device, accessory or packaging 36 that it is attached to, can be configured having a user interface. The user interface can be configured to turn the display on/off, and/or to change the content being displayed on the display screen. In an example, the user interface 50 can be provided by the display itself, e.g., all or a portion of the display can be touch sensitive to activate an on/off feature of the display. In another example, the display can include a user interface 50 in the form of a switch or other element configured to provide on/off display activation by a user. Alternatively, on/off activation of the display can be controlled by a user interface 52, e.g., in the form of a button, switch or the like, on the device, accessory or packaging 36 that the display is attached to or connected with.

In addition to on/off activation, the user interface 50 on the display 32 or the user interface 52 on the device, accessory or packaging that it is connected to can be configured to change the display content being shown on the screen. In an example, the display itself may include such user interface 50, e.g., in the form of touch-screen activation or in the form of a discrete switch or button. Alternatively, the change display content feature can be provided by a user interface 52, e.g., in the form of a button, switch or the like, on the device, accessory or packaging that the display is attached to or connected with.

Displays as disclosed herein can be used with a variety of different relatively small devices, accessories, and/or packaging for the same that would benefit from the ability of being able to provide to a consumer or user a greater amount of information and/or data relating to the device or accessory in a single label than that currently possible using conventional printed labels. In an example, such device is an electrical device.

FIG. 4 illustrates an example electrical device in the form of a hearing prosthesis component 60. In an example, the hearing prosthesis component 60 is an external component that is worn by the hearing prosthesis recipient, e.g., adjacent to the recipient's ear. The hearing prosthesis component 60 generally comprises a housing 62 having an external surface 64, wherein the display 66 is attached to the external surface 64, and wherein the combination of the display and the device comprises an assembly.

The hearing prosthesis external component 60 can be one that is used with different types of hearing prosthesis, such as with a cochlear implant, a percutaneous bone conduction system, and the like. While particular types of hearing prosthesis have been disclosed, it is to be understood that displays as disclosed herein can be used with a variety of different hearing prosthesis having an external component, and such are understood to be within the scope of what is disclosed herein. In the example illustrated in FIG. 3, the external component 30 comprises a sound input device and sound processor used in conjunction with a percutaneous bone conduction hearing prosthesis.

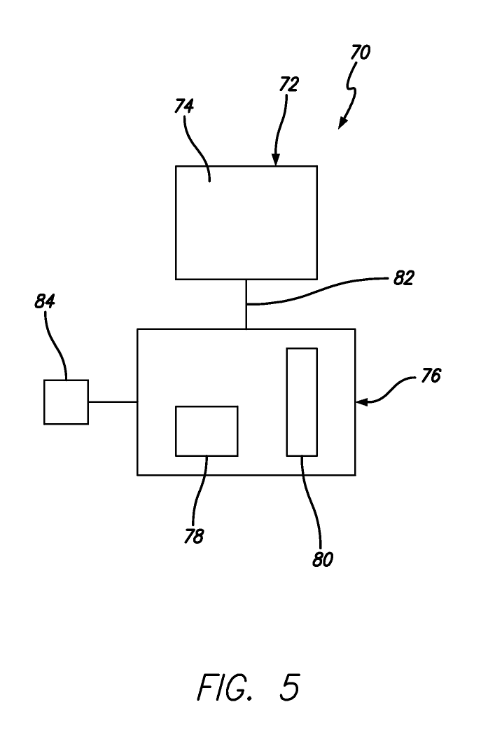

FIG. 5 illustrates in block form elements of the display construction 70 as disclosed above and illustrated in FIG. 4, comprising the display attached to a hearing prosthesis external component. Specifically, the construction 70 comprises the display 72 attached to an external surface of the hearing prosthesis external component 76. In this example, the display 72 is attached by conventional technique such as by adhesive or mechanical means, such that a display screen 74 is easily viewable from the surface of the display. The display is powered by a battery 78 that is disposed within the hearing prosthesis external component 76 and that is connected to the display by a cable 82 or the like. The display content for the display is stored in a memory element 80 that is also disposed within the hearing prosthesis external component 76 and that can be connected to the display by the same cable 82 used to direct power or a separate cable. In this example, a display user interface 84 is disposed on the hearing prosthesis external component, and is configured to provide on/off operation of the display and/or to change the content being directed to the display device.

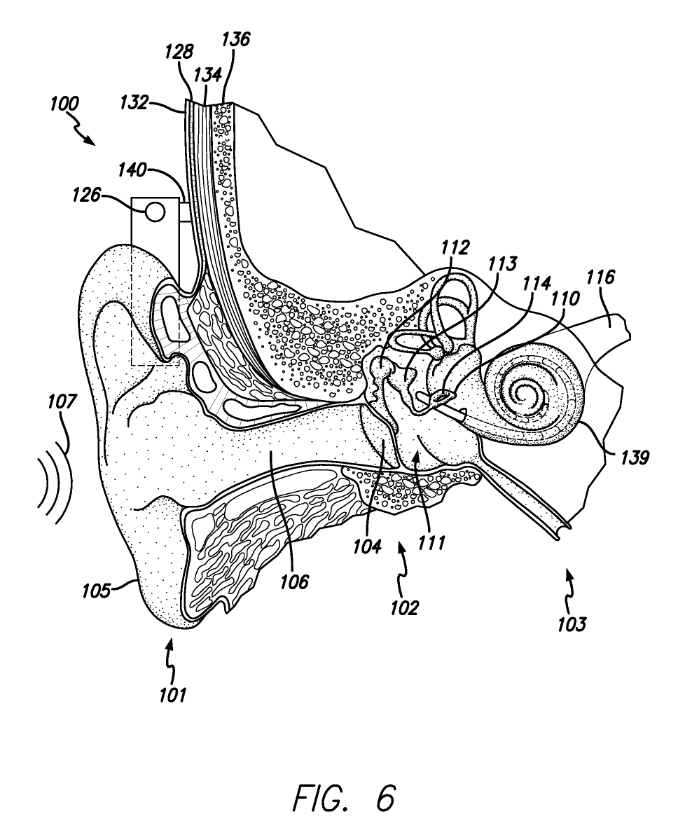

FIG. 6 illustrates an example percutaneous bone conduction hearing prosthesis 100 positioned behind outer ear 101 of the recipient, and comprises a sound input element 126 to receive sound signals 107. The sound input element 126 can be a microphone, telecoil or similar. In the present example, sound input element 126 may be located, for example, on or in bone conduction device 100, or on a cable extending from bone conduction device 100.

Also, bone conduction device 100 comprises a sound processor (not shown), a vibrating electromagnetic actuator and/or various other operational components. More particularly, sound input device 126 converts received sound signals into electrical signals. These electrical signals are processed by the sound processor. The sound processor generates control signals that cause the actuator to vibrate. In other words, the actuator converts the electrical signals into mechanical force to impart vibrations to skull bone 136 of the recipient. Bone conduction device 100 further includes coupling apparatus 140 to attach bone conduction device 100 to the recipient.

In the example of FIG. 6, coupling apparatus 140 is attached to an anchor system (not shown) implanted in the recipient. An exemplary anchor system (also referred to as a fixation system) may include a percutaneous abutment fixed to the recipient's skull bone 136. The abutment extends from skull bone 136 through muscle 134, fat 128 and skin 132 so that coupling apparatus 140 may be attached thereto. Such a percutaneous abutment provides an attachment location for coupling apparatus 140 that facilitates efficient transmission of mechanical force.

A feature of such displays as disclosed herein is that they enable user customer or user access to a greater extent of content and information than otherwise possible from conventional printed labels. For example, displays as disclosed herein can be configured to provide a wide variety of information and/or data, projected onto the display label screen in different screen shots or pages, wherein such information and/or data can relate to the specifications of the device and/or accessory, any upgraded features of the device made after purchase, e.g., such as hardware and/or software revisions or upgrades, the operational status of the device, and/or information and/or data relating to past events, e.g., operating events logged or recorded into a memory of the device for user access. These are but a few examples of the type of information and/or data that can be conveyed to a customer and/or user by displays as disclosed herein, and it is to be understood that many more types of information and/or data relating to the device not expressly disclosed herein is intended to be within the scope of this description.

Further, the display can be configured to enable user customization on what types of information and/or images are being displayed. For example, a user may desire that the display project or display a certain image and/or color and/or other visible indicia in the background or the information or data being provided, or independently as a screen saver or the like. The options provided a user for such customization can be stored in a memory of the device that the display is attached to. Additionally, the display can be configured to receive new or updated display content, e.g., by transfer of such information to the display itself and/or to the electrical device that it is attached to.

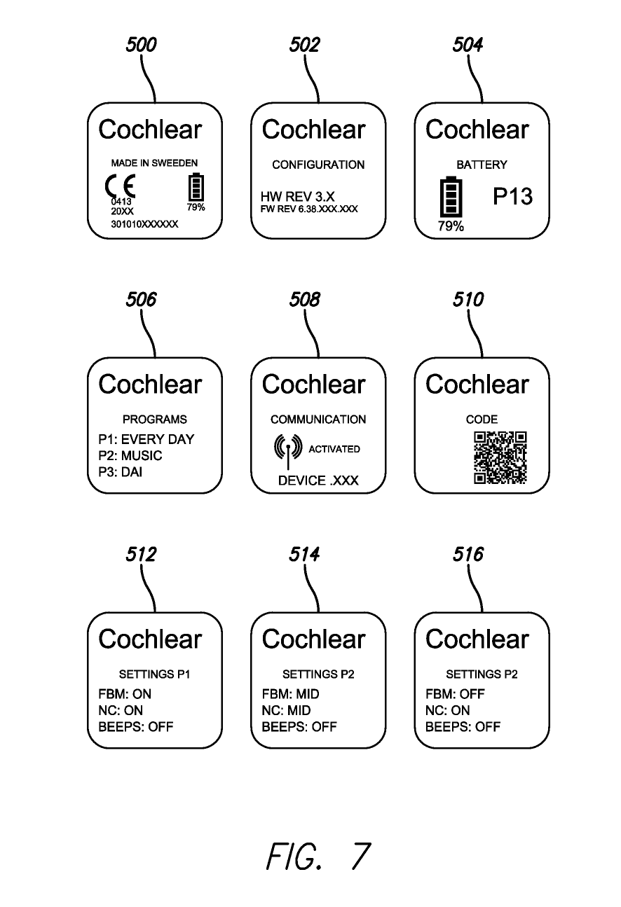

FIG. 7 illustrates examples (500, 502, 504, 506, 508, 510, 512, 514 and 516) of different display content as projected onto the screen of the display as used in conjunction with an example electrical device in the form of a hearing prosthesis. Display content 500 displays some of the basic information relating to the manufacturer of the device, the device model, the location where the device was made, the manufacture date, the orientation of the device (e.g., right or left), and the charge state of the battery. Display content 502 illustrates different information relating to the hardware and any revisions relating thereto of the device. Display content 504 illustrates information showing the model of battery that is used along with the battery state of charge. Display content 506 illustrates the different modes or programs of electrical device operation as well as the current mode of device operation. Display content 508 illustrates information showing the communication status of the electrical device, e.g., whether the device's communication function is or is not activated.

Display content 510 illustrates information showing a code that can be used, e.g., in conjunction with a reader and a computer, to obtain further information and/or data relating to the electrical device. Display content 512 illustrates information showing a first set of operational settings of the device as well as the current state of such settings. Display content 514 illustrates a second set of operation settings as well as the current state of such other settings. Display content 516 illustrates a third set of operation settings as well as the current state of such other settings.

In an example, the display receives display content from a memory of the device that it is attached to. The display content can be amended, revised or upgraded by changing the memory content of the device. The display content received from the memory is projected on the display screen for viewing by a user. The screen can be activated when the device is turned on, showing a first page of display content. The screen is active for a predetermined amount of time before shutting down for the purpose of conserving battery power. The display is operated manually by either touching the screen itself, touching a user interface element on the display, or by touching a user interface element on the device that the display is attached to. When such user interface is not touched or otherwise actuated for a predetermined amount of time, the display is powered down or turned off. As noted above, the display is connected to the device it is attached to by cable or by wireless connection. When the connection is interrupted or disconnected, the display is turned on providing a display content indicating that communication or connection with the electrical device has been interrupted or broken.

The different display content screens described above and illustrated in FIG. 7 have been provided as examples for a particular electrical device, e.g., a hearing prosthesis. It is understood that such display content has been provided for purposes of example and reference, and that many other types of display content are possible and such is intended to be within the scope of the display and devices comprising the same as disclosed herein.

Certain examples of assemblies, displays, devices, accessories, and packaging comprising the same, and display content provided by such displays have been disclosed. While such assemblies, displays and devices, accessories, and packaging have been described with respect to a limited number of examples, the specific features of one example should not be attributed to other examples. No single example is representative of all aspects of displays and devices comprising the same as disclosed herein. In some examples, the assemblies, displays and devices comprising the same comprise features or content different from and/or not mentioned herein. Variations and modifications from the described examples exist. The different display content for such displays as disclosed may be provided in any sequence or order or configuration unless otherwise indicated. Finally, any number disclosed herein should be construed to mean approximate, regardless of whether the word “about” or “approximately” is used in describing the number. The appended claims intend to cover all those modifications and variations as falling within the scope of the displays and methods for making the same as disclosed herein.

What is claimed is:

1. An assembly comprising:
a device having an external surface and being wearable on a person's body;
a display disposed on or adjacent to the device external surface, wherein the display is configured to display content relating to the device upon activation.

2. The assembly as recited in claim 1 wherein the display comprises an input for receiving a signal from the device.

3. The assembly as recited in claim 1, wherein the display is a thin-film construction.

4. The assembly as recited in claim 3 wherein the display is activated by means provided by the device.

5. The assembly as recited in claim 3 wherein the display is activated by means provided independent of the device.

6. The assembly as recited in claim 3 wherein the display is activated by means provided by the display.

7. The assembly as recited in claim 1 wherein the assembly comprises means for changing the content that is displayed by the display.

8. The assembly as recited in claim 7 wherein the means for changing is part of the display.

9. The assembly as recited in claim 7 wherein the means for changing is part of the device.

10. The assembly as recited in claim 7 wherein the means for changing is independent of the device.

11. The assembly as recited in claim 7 wherein the content that is displayed changes depending on the recipient.

12. The assembly as recited in claim 1 wherein the display is electrically connected with the display configuration.

13. The assembly as recited in claim 1 wherein the display content is stored by the device.

14. The assembly as recited in claim 1 wherein the device is an electrical device, and wherein the display is attached to the device.

15. The assembly as recited in claim 1 wherein the device is a component of a hearing prosthesis.

16. A system for providing information relating to an electrical device, the system comprising:
a display attached to the device, wherein the display comprises a screen for displaying information relating to the device;
means for activating the display; and
means for changing the information displayed on the display.

17. The system as recited in claim 16 wherein the information for displaying on the display is stored by the device.

18. The system as recited in claim 16 wherein the information that is displayed is different depending on the intended recipient of the information.

19. The system as recited in claim 16 wherein the display is electrically connected with the device.

20. The system as recited in claim 16 wherein the means for activating is provided by the device.

21. The system as recited in claim 16 wherein the means for changing the display information is provided by the display.

22. The system as recited in claim 16 wherein the device is a component of a hearing prosthesis.

23. The system as recited in claim 22 wherein the component is one that is worn by a recipient adjacent an ear of the recipient.

24. An assembly comprising:
a component of a hearing prosthesis; and
a display having a screen and being configured to provide display content relating to the hearing prosthesis, the display being operatively coupled to the hearing prosthesis.

25. The assembly as recited in claim 24 further comprising a user interface to activate the display.

26. The assembly as recited in claim 24 further comprising a user interface to change the display content for display on the screen.

27. The assembly as recited in claim 24 where the display is powered by the hearing prosthesis.

28. The assembly as recited in claim 27 wherein the display content is stored in the hearing prosthesis.

29. The assembly as recited in claim 24 wherein the display is a thin-film construction.

30. A method for receiving information relating to a device comprising the steps of:
activating a display operatively coupled to the device; and
viewing a screen of the display to receive information relating to the device.

31. The method as recited in claim 30 wherein the step of activating involves a interacting with a user interface on one or both of the device or the display.

32. The method as recited in claim 30 further comprising a step of changing the information being viewed on the display by interacting with one or both of the device and the display.

33. The method as recited in claim 30, wherein the information for display is provided by the device.

34. The method as recited in claim 30, wherein during the step of activating, the display is electrically powered by the device.

35. The method as recited in claim 30 wherein during the step of viewing, the information received from the display is different depending on the recipient.

36. The method as recited in claim 30 wherein the display is disposed on an external surface of the device.

37. The method as recited in claim 30 wherein the device is a medical device.

38. The method as recited in claim 30 wherein the device is a hearing prosthesis or an accessory that is used therewith.
